(19) United States
(12) Patent Application Publication
(10) Pub. No.: US 2014/0129777 A1
(43) Pub. Date: May 8, 2014

(54) SYSTEMS AND METHODS FOR DYNAMIC DATA STORAGE

(71) Applicant: Tencent Technology (Shenzhen) Company Limited, Shenzhen (CN)

(72) Inventor: Jiesheng JIN, Shenzhen (CN)

(73) Assignee: Tencent Technology (Shenzhen) Company Limited, Shenzhen (CN)

(21) Appl. No.: 14/105,091

(22) Filed: Dec. 12, 2013

Related U.S. Application Data
(63) Continuation of application No. PCT/CN2013/086103, filed on Oct. 29, 2013.

(30) Foreign Application Priority Data
Nov. 2, 2012 (CN) 201210433837.6

(51) Int. Cl. G06F 12/08

(52) U.S. Cl. CPC G06F 12/0891
USPC 711/133

(57) ABSTRACT

A data caching method is performed to receive an instruction to operate based on a specific data set; determine whether the specific data set is cached in its memory; when the specific data set is not cached in the memory, determine a plurality of attributes for a plurality of data sets currently stored in the memory, determine whether these attributes satisfy data caching criteria for storing the specific data set, and furthermore, when the data caching criteria are not satisfied, select at least one of the plurality of data sets according to a data replacement rule, delete at least a portion of the selected data set from the memory, and download the specific data set from a remote source; operate the specific data set according to the user instruction; and store at least a portion of the specific data set in the memory.

### RELATED APPLICATIONS

This application is a continuation application of PCT Patent Application No. PCT/CN2013/086103, entitled “METHOD AND DEVICE FOR STORING ONLINE AUDIO DATA” filed on Oct. 29, 2013, which claims priority to Chinese Patent Application No. 201210433837.6, entitled “METHOD AND DEVICE FOR STORING ONLINE AUDIO DATA,” filed on Nov. 2, 2012, both of which are incorporated by reference in their entirety.

### FIELD OF THE INVENTION

The present application relates to the field of data processing technologies, and in particular, to methods, systems and devices for storing or caching a specific data set in a dynamic manner during the course of executing a software application that operates based on multiple data sets including the specific data set.

### BACKGROUND OF THE INVENTION

Client devices (e.g., mobile phones) are widely applied in our daily life, offering unprecedented user experience due to their readily accessible and extremely accommodating attributes. The unprecedented user experience is largely enabled by tremendous amount of software applications developed on various client device platforms. As of January 2013, 900,000 applications are available for downloading in the Apple App Store by iPhone or iPad users. In accordance with the large number of software applications, large volumes of data are processed in the client devices and oftentimes require the client devices to develop a strong data processing capability.

As a specific example, an audio player is normally implemented on a client device to play audio clips from audio data that are received from the Internet. In one situation, a respective data set for each audio chip is cached locally in a memory every time the clip is played, but cleared from the memory afterwards. In particular, a mobile phone has to receive the respective data set as a data packet via the General Packet Radio Service (GPRS), and the respective data set is sometimes transmitted between the mobile phone and a corresponding data source every time the audio player plays the audio clip, unnecessarily wasting the bandwidth of the communication network.

However, in another situation, a respective data set for each audio clip played at the client device is cached and stored locally in the memory, such that when the audio player needs to play the respective audio clip, the respective data set is directly extracted from a memory of the client device. As more audio data sets are cached in a local memory, the available memory space is reduced at the client device, and at some point, the user has to manually organize the audio clips by removing some audio clips. Such manual organization of audio clips would bring inconvenience to the user, and compromise the corresponding user experience with the audio player.

Therefore, it is desirable to provide a method and system that proactively and efficiently manages storage of data, such as those for audio clips, received via a communication network during the course of executing instructions in a software application to process the data sets.

### SUMMARY

The above deficiencies and other problems associated with the conventional approaches of caching data received from a communication network are reduced or eliminated by the invention disclosed below. In some embodiments, the invention is implemented in a client machine that has one or more processors, memory and one or more modules, programs or sets of instructions stored in the memory for performing multiple functions. Instructions for performing these functions may be included in a computer program product configured for execution by one or more processors.

One aspect of the invention is a computer-implemented method of caching data that includes, at a client device having one or more processors and memory for storing programs to be executed by the one or more processors, receiving an instruction to operate based on a specific data set and determining whether the specific data set is cached in the memory. The method further includes in accordance with a determination that the specific data set is not cached in the memory: determining a plurality of attributes associated with a plurality of data sets currently stored in the memory, wherein the plurality of attributes at least include a number of data sets in the plurality of data sets and a total size of the plurality of data sets; determining whether the plurality of attributes satisfy data caching criteria for storing the specific data set in the memory; and further in accordance with a determination that the data caching criteria are not satisfied: selecting at least one of the plurality of data sets according to a data replacement rule, deleting at least a portion of the selected data set from the memory, and downloading the specific data set from a remote source. The method further includes operating the specific data set according to the user instruction and storing at least a portion of the specific data set in the memory.

Another aspect of the invention is a client device that includes one or more processors and memory having instructions stored thereon, which when executed by the one or more processors cause the processors to perform operations to receive an instruction to operate based on a specific data set and determine whether the specific data set is cached in the memory. The processors in the client device further perform operations to in accordance with a determination that the specific data set is not cached in the memory: determine a plurality of attributes associated with a plurality of data sets currently stored in the memory, wherein the plurality of attributes at least include a number of data sets in the plurality of data sets and a total size of the plurality of data sets; determine whether the plurality of attributes satisfy data caching criteria for storing the specific data set in the memory; and further in accordance with a determination that the data caching criteria are not satisfied: select at least one of the plurality of data sets according to a data replacement rule, delete at least a portion of the selected data set from the memory, and download the specific data set from a remote source. The processors in the client device further perform operations to operate the specific data set according to the user instruction and store at least a portion of the specific data set in the memory.

Another aspect of the invention is a non-transitory computer-readable medium, having instructions stored thereon, which when executed by one or more processors cause the processors to perform operations to receive an instruction to operate based on a specific data set and determine whether the specific data set is cached in the memory. The processors in the client device further perform operations to in accordance with a determination that the specific data set is not cached in the memory: determine a plurality of attributes associated with a plurality of data sets currently stored in the memory, wherein the plurality of attributes at least include a number of data sets in the plurality of data sets and a total size of the plurality of data sets; determine whether the plurality of attributes satisfy data caching criteria for storing the specific data set in the memory; and further in accordance with a determination that the data caching criteria are not satisfied: select at least one of the plurality of data sets according to a data replacement rule, delete at least a portion of the selected data set from the memory, and download the specific data set from a remote source. The processors in the client device further perform operations to operate the specific data set according to the user instruction and store at least a portion of the specific data set in the memory.

Other embodiments and advantages may be apparent to those skilled in the art in light of the descriptions and drawings in this specification.

### BRIEF DESCRIPTION OF THE DRAWINGS

The aforementioned features and advantages of the invention as well as additional features and advantages thereof will be more clearly understood hereinafter as a result of a detailed description of preferred embodiments when taken in conjunction with the drawings.

FIGS. 1A and 1B illustrate a flow chart for an exemplary computer-implemented method of caching data according to some embodiments in the invention.

FIG. 2 illustrates a flow chart for an exemplary computer-implemented method of caching audio data for the purpose of playing audio clips according to various embodiments in the invention.

FIG. 3 illustrates a block diagram of an exemplary data caching system according to various embodiments in the invention.

FIG. 4 illustrates a block diagram of an exemplary client device according to various embodiments in the invention.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

Description of each embodiment in the following is made with reference to the accompanying drawings, so as to exemplify specific embodiments capable of being implemented in the present application. Direction words mentioned in the present application, for example, “upper”, “lower”, “front”, “back”, “left”, “right”, “inner”, “outer”, and “side surface” only refer to directions of the accompanying drawings. Therefore, the used direction words are used to illustrate and understand the present application, instead of limiting the present application. In the drawings, units with a similar structure may be represented by the same numeral.

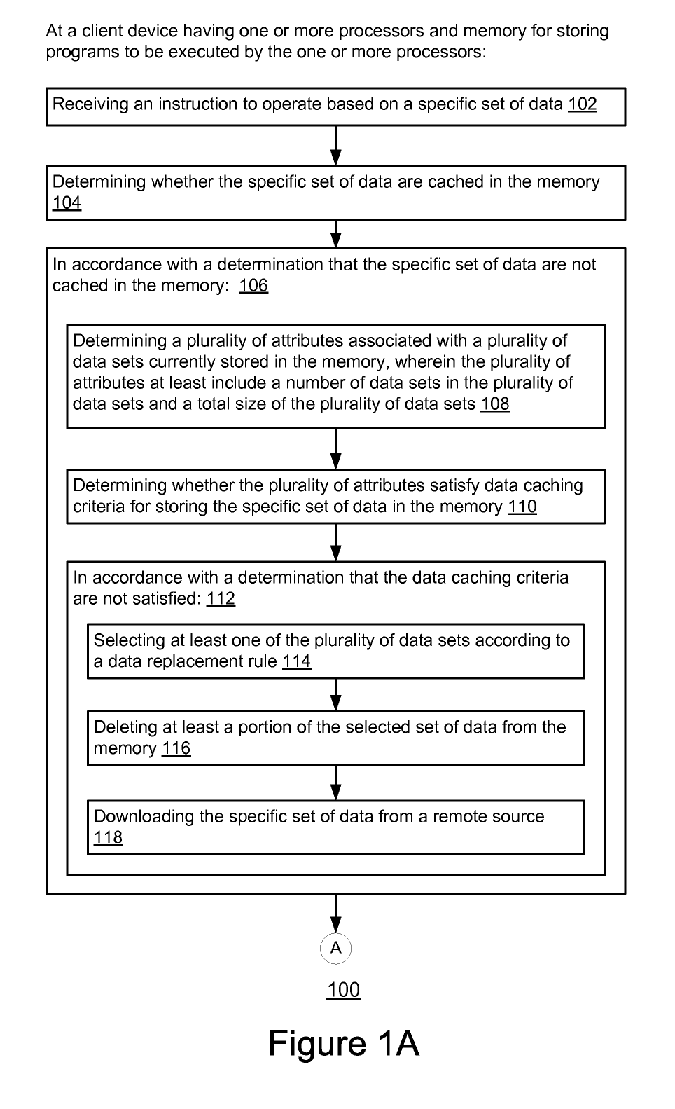

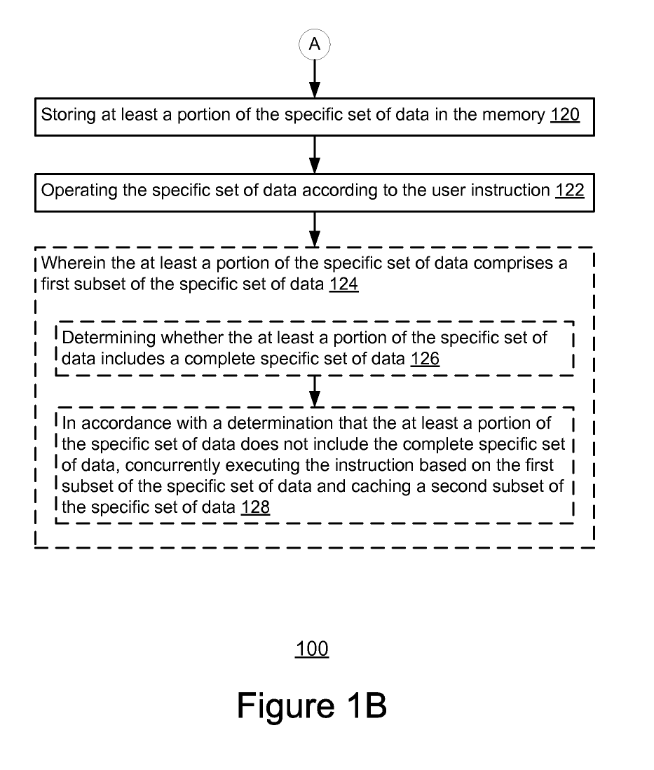

FIGS. 1A and 1B illustrate a flow chart for an exemplary computer-implemented method 100 of caching data according to some embodiments in the invention. Method 100 is, optionally, governed by instructions that are stored in a non-transitory computer readable storage medium and that are executed by one or more processors of a client device. Each of the operations shown in FIGS. 1A and 1B may correspond to programs or instructions stored in a computer memory or non-transitory computer readable storage medium. The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 100 may be combined and/or the order of some operations may be changed.

Method 100 is performed by a client device that may preferably include, but is not limited to, a desktop or laptop computer, a mobile phone, a tablet computer, or a Personal Digital Assistant (PDA). The client device receives (102) an instruction to operate based on a specific data set. In some implementations, the instruction is a part of a software application that is installed on the client device to play music thereon, and therefore, the specific data set include audio data that are played by the software application. As a specific example, the specific data set is associated with an audio clip for a specific song. Similarly, in some other implementations, the instruction is used to play a certain video clip, and the specific data set include video data for the video clip. Alternatively, in some implementations, the instruction is used to process a voice message, and the specific data set includes voice data for the voice message.

After receiving the instruction, the client device determines (104) whether the specific data set is cached in its memory. Under some circumstances, it is determined that the specific data set is already cached in the memory. The cached specific data set is then extracted from the memory for execution of the instruction.

However, when it is determined (106) that the specific data set is not cached in the memory, the client device further determines (106) a plurality of attributes associated with a plurality of data sets that are currently stored in the memory. The plurality of attributes include at least a number of data sets in the plurality of data sets and a total size of the plurality of data sets. In some implementations, each of the plurality of data sets is cached in a temporary file in the memory. Optionally, the plurality of data sets occupy a portion or all of available memory space that is allocated to cache data sets associated with the corresponding software application.

After determining the plurality of attributes, the client machine further determines (110) whether the plurality of attributes satisfy data caching criteria for storing the specific data set in the memory. This data caching criteria are set forth to determine whether the client device is capable of storing more data sets in view of the existing data sets in its memory. As a specific example of the data caching criteria, the number of data sets in the plurality of data sets are required to be less than a threshold number, and the total size of the plurality of data sets cannot exceed another threshold value that is associated with the total size of the memory allocated to cache data sets of the corresponding software application. In some embodiments, the threshold number is set as 10 for the number of data sets in the plurality of data sets, and the allocated total size of the memory for caching the data sets of the corresponding software application is 100 megabytes (MB). Therefore, the total size of the plurality of data sets has to be controlled below a threshold value that is calculated by deducting the allocated total size of the memory, e.g., 100 MB, by the size of the portion or all of the specific data set that will be stored in the memory.

In some situations, the data caching criteria are satisfied by the plurality of attributes (e.g., the number of data sets and the total size of the plurality of data sets). Sufficient memory space is available to store both the plurality of data sets that are already stored in the memory and the specific data set that waits to be stored. The specific data set can thereby be stored or cached in the memory without deleting any of the plurality of data sets cached in the memory.

On the other hand, when the data caching criteria are not satisfied (112) by the plurality of attributes, a sequence of operations are implemented as described herein. The client device selects (114) at least one of the plurality of data sets according to a data replacement rule. At least a portion of the selected data set is deleted (116) from the memory for sparing some memory space, such that the specific data set may be stored. Thereafter, the specific data set is then downloaded (118) from a remote source, e.g., a music server, a video server, and a message server that is owned by a communication service provider.

Further, upon downloading the specific data set from the remote source, the client device stores (120) at least a portion of the specific data set in its memory and operates (122) on the specific data set according to the user instruction, e.g., playing music using an application program. In some embodiments, the portion of the specific data set includes (124) a first subset of the specific data set. It is then determined whether the portion of the specific data set includes (126) a complete specific data set. In accordance with a determination that the portion of the specific data set does not include the complete specific data set, the client device concurrently executes (126) the instruction based on the first subset of the specific data set and caches (128) a second subset of the specific data set.

The data replacement rule determines which data set among the plurality of data sets needs to deleted, such that some memory space is cleaned up for caching the specific data set. In accordance with many embodiments of the invention, a default data replacement rule is predetermined when the corresponding software application is installed on the client device, and a user can optionally change the settings of the software application by deleting or revising the default data replacement rule or by adding one or more custom data replacement rules.

In some implementations, the data replacement rule allows the user to exempt one or more data sets that are currently stored in the memory of the client device from being selected and deleted. From another perspective, the user has the option to determine that a list of data sets currently cached in the memory of the client device are not included in the plurality of data sets, such that data sets in the list of data sets are not selected according to the data replacement rule or deleted to spare memory space the specific data set. In one example, an important voice message can never be selected and deleted, even though it has been stored at a much earlier time than many other messages and has not been listened to for a long period of time. Similarly, in another example, a mother has stored a children's song in her mobile phone for a long time. Although she has not played the song for her kid recently, the mother wants to keep this song available whenever the kid requests it. Therefore, the mother can configure the data replacement rule in her mobile phone to keep this specific song from being selected or deleted, when another song needs to be downloaded and stored locally.

In accordance with various embodiments of the invention, the data replacement rule is formulated based on one or more factors including the respective size, caching time, frequency of usage, time of the most recent usage, and many other relevant features of each data set in the plurality of data sets. For instance, in some implementations, the specific data set constitute a first data set, and the plurality of data sets include a second data set that are cached in the memory before other data sets in the plurality of data sets. In accordance with the data replacement rule, the second data set is selected, and at least a portion of the second data set is deleted to spare memory space for caching the portion of the first data set in the memory.

Optionally, in some implementations, the size of the specific data set is smaller than a respective size of at least one data set in the plurality of data sets, and the at least one data set has a respective larger size than the specific data set. In accordance with the data replacement rule, a third data set is selected from the at least one data set, because the third data set have a size closest to that of the specific data set.

Optionally, in some implementations, the specific data set comprises a first data set, and the plurality of data sets include a fourth data set that have not been used or accessed for a longest period time among the plurality of data sets. In accordance with the data replacement rule, the fourth data set is selected, and at least a portion of the fourth data set is deleted to spare memory space for caching the portion of the first data set in the memory. Optionally, in some implementations, in accordance with the data replacement rule, a respective frequency of execution is tracked for each data set of the plurality of data sets, and the selected data set have the lowest frequency of usage among the plurality of data sets.

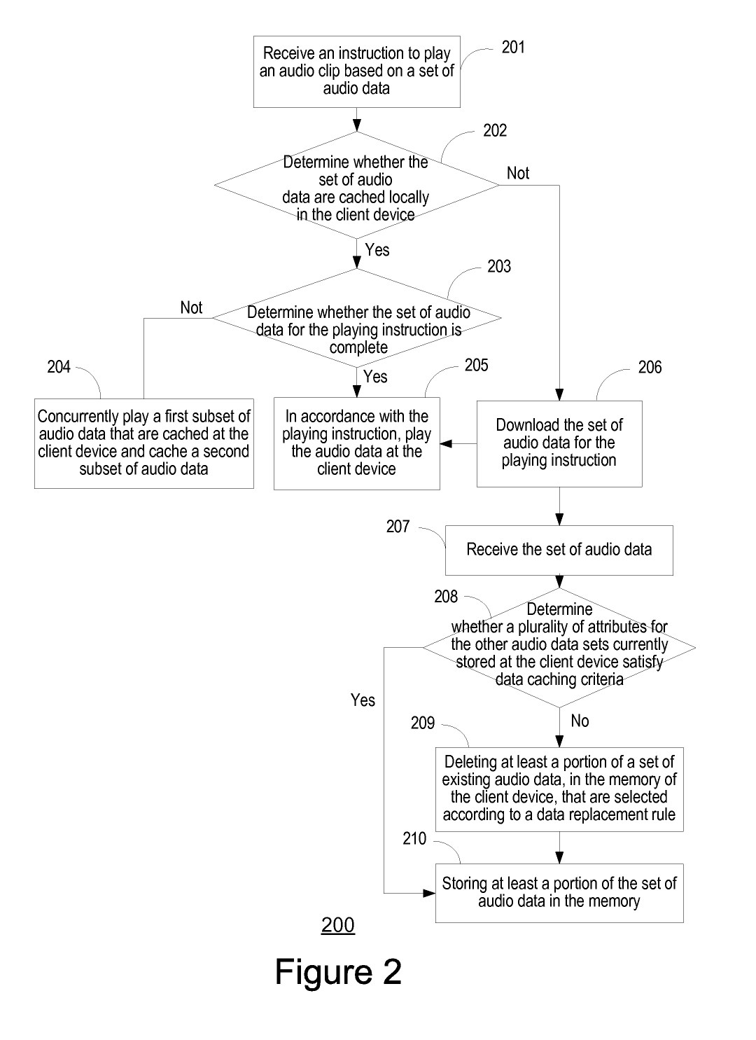

It should be understood that the particular order in which the operations in FIGS. 1A-1B have been described are merely exemplary and are not intended to indicate that the described order is the only order in which the operations could be performed. One of ordinary skill in the art would recognize various ways to cache and distribute specific data as described herein. Additionally, it should be noted that details of other processes described herein with respect to method 200 (e.g., FIG. 2) are also applicable in an analogous manner to method 100 described above with respect to FIGS. 1A-1B. For brevity, these details are not repeated here.

From another perspective, after the specific data set is stored in the memory of the client device, the specific data set become one data set included in the plurality of data sets. Next time, in response to an instruction to operate on the specific data set, they are directly extracted from the memory of the client device, rather than being received via the GPRS. Therefore, the bandwidth of the GPRS are preserved and managed in a more efficient manner, while a wait time for data loading is also shortened in accordance with such local extraction of the specific data set.

In some implementations as shown in FIG. 1B, the specific data set is broken into multiple data subsets (e.g., the first subset and the second subset) for dynamic data storage. Such implementations are particularly useful when the specific data set has a large data volume or when the remaining available memory space is limited for accommodating the entire set of the specific data set. The first and second subsets of the specific data set is segmented at a break point. During the concurrent operations at operation 128, the break point is identified for initializing the caching of the specific data set from this break point. Therefore, the first subset of the specific data set that exists in the memory is still used for executing the instruction without being downloaded again, while the second subset of the specific data is being downloaded as a background task. This concurrent arrangement wins ample time for downloading and storing the second subset of the specific data set, shortens a wait time by the user, and ultimately reaches a goal of improving the user experiences of the corresponding software application.

In addition, the client device is able to proactively maintain a dynamic data storage process based on the data caching criteria and the data replacement rule(s). Optionally, the user of the client device may enable desirable options or defines custom criteria and rules prior to and during the course of operating the corresponding software application. Optionally, a set of default criteria and rules are predetermined and relied on to manage the dynamic data storage process. Therefore, the user does not need to manually manage individual data sets in the plurality of data sets that are stored in the memory of the client device for the specific software application. By this means, user invention is reduced, and therefore, user experience is further improved.

FIG. 2 illustrates a flow chart for an exemplary computer-implemented method of caching audio data for the purpose of playing audio clips according to various embodiments in the invention. Method 200 is, optionally, governed by instructions that are stored in a non-transitory computer readable storage medium and that are executed by one or more processors of a client device. Each of the operations shown in FIG. 2 may correspond to programs or instructions stored in a computer memory or non-transitory computer readable storage medium. The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 200 may be combined and/or the order of some operations may be changed.

Like method 100, method 200 is also performed by a client device that may preferably include, but is not limited to, a desktop or laptop computer, a mobile phone, a tablet computer, or a PDA. In particular, method 200 exemplifies a sequence of operations implemented to cache audio data for a software application (e.g., a music player) installed on the client device. The client device receives (201) a playing instruction to play an audio clip based on a set of audio data. In some embodiments, the audio clip is associated with a song or a voice message. In one specific example, the playing instruction is issued when a user of the client device selects a song named “Great China,” and the client device obtains the corresponding audio data from a remote source, e.g., a music server, via a communication network.

In various embodiments of the invention, the client device obtains the audio data by different means. In some circumstances, when the client device is a cellular phone, the client device is communicatively coupled to the Internet via a radio network or a Wi-Fi network, and receives the corresponding audio data based on the General Packet Radio Service (GPRS) through the Internet.

After receiving the playing instruction, the client machine determines (202) whether the set of audio data for the specific clip are cached locally in the memory of the client device. On one hand, upon a determination that the set of audio data are cached locally in the client device, it is further determined (203) whether the set of audio data for the playing instruction is complete. In some situations, when the set of audio data is not complete, the corresponding media player on the client device concurrently plays (204) a first subset of audio data that are currently cached at the client machine, and downloads (204) a second subset of audio data that are not stored in its memory yet. The first subset of audio data and the second subset of audio data form a complete set of audio data. However, in some other situations, the set of audio data are cached locally in the memory, and the set of audio data are complete. The corresponding media player plays (205) the audio data from the client device according to the playing instruction.

On the other hand, when the set of audio data are not cached locally in the client device, the set of audio data are downloaded (206) from a remote source for the purpose of executing the playing instruction, and then, the media player plays (205) the audio data from the client device according to the playing instruction.

In some implementations, the set of audio data are not only downloaded, but also stored or cached in the memory of the client device. During the course of downloading the set of audio data, the client device also receives (207) the set of audio data. The client device determines (208) whether a plurality of attributes satisfy data caching criteria for the other audio data sets that are currently stored at the client device. More accurately, the data caching criteria are set forth to determine whether the client device is capable of storing more audio data sets in view of the existing audio data sets. As explained above, in some implementations, the number of data sets in the audio data sets currently stored in the memory are required to be less than a threshold number, and the total size of these stored audio data sets cannot exceed another threshold value that is associated with the total size of the memory allocated to cache audio data sets of the corresponding media player. For brevity, these details concerning the threshold number and the other threshold values for the stored audio data in the memory are not repeated here.

When it is determined that the plurality of attributes for the other audio data sets currently stored at the client device satisfy the data caching criteria, sufficient memory space is available to store at least a portion of the set of audio data that needs to be locally stored or cached, and the portion of the set of audio data are therefore cached (210) in the client device.

In contrast, when the plurality of attributes for the other audio data sets currently stored at the client device do not satisfy the data caching criteria, at least a portion of at least one set of existing audio data is deleted (209) from the memory of the client device, and in particular, the at least one set of existing audio data are selected (209) according to a data replacement rule. Upon deletion of the portion of the selected set of existing audio data, at least a portion of the set of audio data are therefore cached (210) in the client device. More details and examples on the data replacement rule are explained above with reference to operation 114 in FIG. 1.

Further, in some implementations, the audio data set for the audio clip that needs to be played are broken into multiple data subsets (e.g., the first subset and the second subset) for dynamic data storage. The first and second subsets of the specific data set is segmented at a break point. In accordance with the determination that the set of audio data for the playing instruction is not complete in operation 203, the break point is identified for initializing the caching of the audio data set from this break point in operation 204. Therefore, the first subset of the audio clip that exists in the memory is promptly played by the media player without being downloaded from the remote source again, and the second subset of the audio clip is downloaded concurrently as a background task. This concurrent data streaming arrangement wins ample time for downloading and storing the second subset of the audio clip. From the perspective of the user that uses the media player, the audio clip is promptly played within a short or negligible wait time, and the user experiences is improved of the corresponding software application.

In some embodiments, a first subset, rather than a complete set, of the respective audio data is stored every time an audio clip needs to be downloaded and stored locally in the memory of the client device. In response to an instruction to play the respective clip, the first subset of the respective audio data set is promptly loaded for playing, and however, one or more subsets of the respective audio data need to be fetched from a remote source, occupying a portion of the communication bandwidth of the client device. However, the shortened wait time and the improved user experience are consistently maintained as a result of this concurrent data streaming arrangement.

In some implementations, when being stored, the set of audio data or each of the existing audio data sets that are currently in the memory is stored in a form of a temporary file.

It should be understood that the particular order in which the operations in FIG. 2 have been described are merely exemplary and are not intended to indicate that the described order is the only order in which the operations could be performed. One of ordinary skill in the art would recognize various ways to cache and distribute specific data as described herein. Additionally, it should be noted that details of other processes described herein with respect to method 200 (e.g., FIG. 2) are also applicable in an analogous manner to method 100 described above with respect to FIG. 1. For brevity, these details are not repeated here.

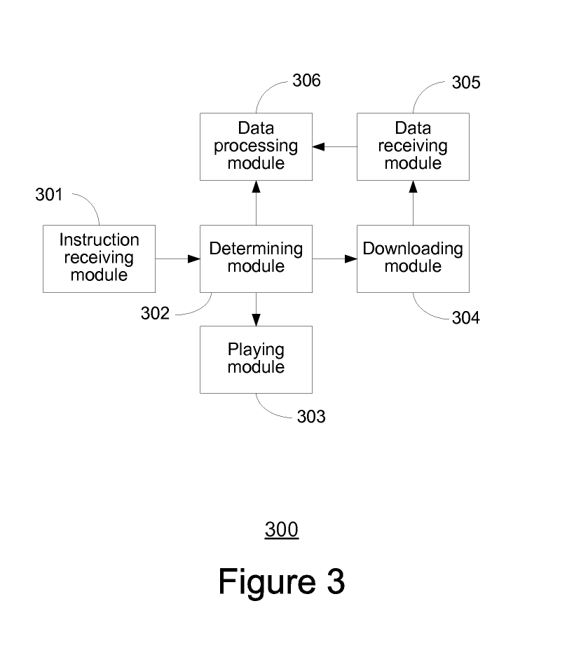

FIG. 3 illustrates a block diagram of an exemplary data caching system 300 according to various embodiments in the invention. The data caching system 300 includes an instruction receiving module 301, a determining module 302, a playing module 303, a downloading module 304, a data receiving module 305, and a data processing module 306. Data caching system 300 receives an instruction to operate based on a specific data set, identifies and processes the specific data set, and then executes the instruction. In many implementations, data caching system 300 is associated with a media player that plays an audio clip according to a playing instruction.

In some implementations concerning a media player, instruction receiving module 301 receives a playing instruction, and this playing instruction corresponds to an audio data set of an audio clip. Determining module 302 determines whether the audio data set corresponding to the playing instruction is stored in the client device. If determining module 302 determines that the audio data set corresponding to the playing instruction is stored in the client device, playing module 303 extracts the corresponding audio data from the memory of the client device for playing. In contrast, if determining module 302 determines that the audio data set corresponding to the playing instruction is not stored in the client device, downloading module 304 downloads the audio data set corresponding to the playing instruction from a remote source, such as a music server.

In some embodiments, determining module 302 further determines whether the audio data set corresponding to the playing instruction is complete for the purposes of playing the corresponding audio clip. If the audio data set is not complete, when playing module 303 plays a first subset of the audio data set that is stored in the client device, downloading module 304 downloads a second subset of the audio data set that is not available in the client device. Optionally, the first subset and the second subset of the audio data set form a complete audio data set.

After downloading module 304 downloads the audio data set, data receiving module 305 receives the audio data set and prepares it for local caching and storage. Determining module 302 further determines whether a plurality of attributes for the other audio data sets currently stored in the client device satisfy data caching criteria. In particular, the allocated memory space may have already been occupied by these other audio data sets and cannot provide sufficient room to accommodate the audio data set that needs to be stored. Therefore, in one specific example, determining module 302 determines whether a total size of the audio data set to be stored and these other audio data sets that are currently stored in the client device exceeds a predetermined threshold value.

Further in the above specific example, if determining module 302 determines that the total size of this audio data set and the other audio data sets exceeds the predetermined threshold value, the data processing module 306 deletes at least a portion of at least one of the other audio data sets from the memory of the client device according to a data replacement rule, and stores at least a portion of the audio data set that needs to be stored in the memory. In one specific example of the data replacement rule, an oldest audio data set that is saved earliest among the other audio data sets is deleted to spare the memory space for the audio data set that needs to be stored. More examples and details on the data replacement rules are explained above with reference to FIG. 1.

Although data caching system 300 is described herein as a part of a media player that plays an audio clip, one of those skilled in the art knows that the data caching system 300 is not so limited and may be broadly applied in any software application that needs to constantly download and store different data sets. When data caching system 300 is used in such a software application, it improves user experience by proactively managing data caching of different data sets, avoiding excessive data downloading, shortening the wait time by the user, and reducing user intervention.

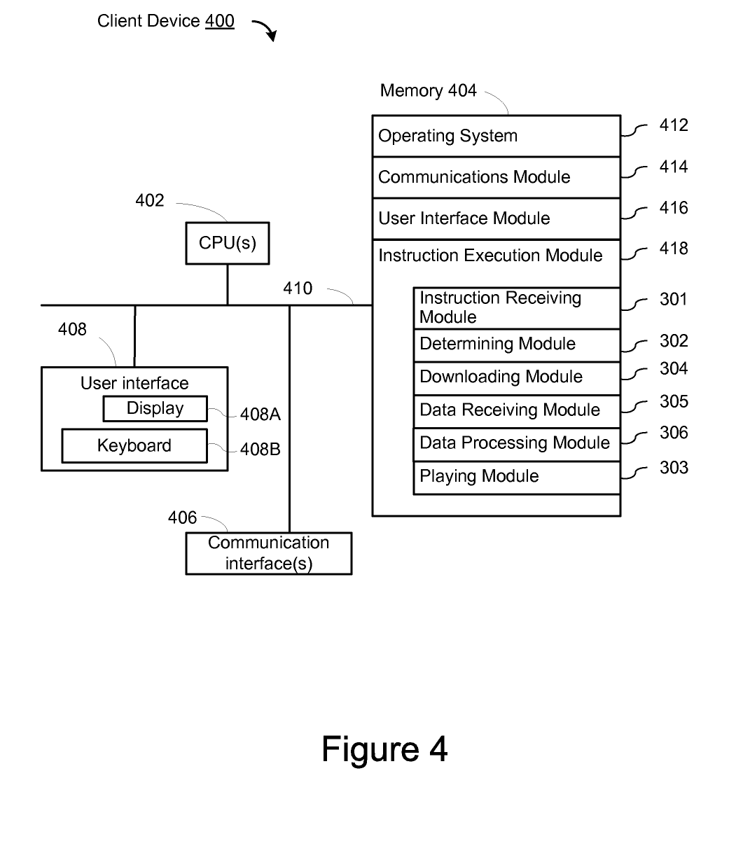

FIG. 4 illustrates a block diagram of an exemplary client device 400 that dynamically caches data according to various embodiments in the invention. In accordance with various embodiments of the invention, client device 400 is applied to implement the data caching methods as shown in FIGS. 1 and 2. In some implementations, client device 400 at least includes one or more processors 402 (e.g., central processing units) and a memory 404 for storing programs and instructions for execution by one or more processors 402. In some implementations, client device 400 further includes one or more communications interfaces 406, a user interface 408, and one or more communications buses 410 that interconnect these components.

In some embodiments, input/output interface 408 includes a display 408A and input devices such as a keyboard 408B, a mouse or a track-pad. In some embodiments, communication buses 410 include circuitry (sometimes called a chipset) that interconnects and controls communications between system components. In some embodiments, memory 404 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. In some embodiments, memory 404 includes one or more storage devices remotely located from the one or more processors 402. In some embodiments, memory 404, or alternatively the non-volatile memory device(s) within memory 404, includes a non-transitory computer readable storage medium.

In some embodiments, memory 404 or alternatively the non-transitory computer readable storage medium of memory 404 stores the following programs, modules and data structures, instructions, or a subset thereof:
Operating System 412 that includes procedures for handling various basic system services and for performing hardware dependent tasks.
Communication module 414 that is used for connecting client device 400 to other machines via a local network or servers (e.g., a remote music server) via one or more network communication interfaces 408 (wired or wireless) and one or more communication networks, such as the Internet, other wide area networks, local area networks, metropolitan area networks, and so on.
User interface module 416 that includes procedures for handling various basic input and output functions through one or more input and output devices.
Instruction execution module 418 that executes instructions in a software application and therefore operates on different data sets.

In some implementations, instruction execution module 418 relates to a media player installed on client device 400 to play music thereon, and therefore, the different data sets include audio data sets that are played by the media player. Thus, in instruction execution module 418, each individual instruction in the media player is implemented based on a specific set of audio data, and plays a single song, voice message or any other audio clips. Optionally, in some other implementations, instruction execution module 418 relates to a video player installed on client device 400 to play video clips thereon, and therefore, the different data sets include media data sets that are played by the video player. Thus, each individual instruction in the video player is implemented based on a specific set of video data.

To execute the instructions in the software application, instruction execution module 418 further includes a data caching system as shown in FIG. 3. This data caching system includes an instruction receiving module 301, a determining module 302, a playing module 303, a downloading module 304, a data receiving module 305, and a data processing module 306. In some implementations, instruction receiving module 301 receives an instruction that is executed to operate based on the specific data set. Determining module 302 determines whether the specific data set corresponding to the instruction is stored in client device 400. If determining module 302 determines that the specific data set is stored in the client device, playing module 303 obtains the specific data set from a memory of client device 400 for executing the instruction; and if determining module 302 determines that the specific data set corresponding to the instruction is not stored in client device 400, downloading module 304 downloads the specific data set from a remote source via a communication network.

Additionally, in some implementations, determining module 302 further determines whether the specific data set is complete for the purposes of executing the instruction. If the specific data set is not complete and only a first subset of the specific data set is stored in the client device, playing module 303 initializes to execute the instruction based on the first subset of the specific data set, while downloading module 304 concurrently downloads a second subset of the specific data set that is not available in client device 400. Optionally, the first subset and the second subset of the specific data set form a complete specific data set.

After downloading module 304 downloads the specific data set, data receiving module 305 receives the specific data set for storage in memory 404 of client device 400. Determining module 302 further determines whether data caching criteria are satisfied for a plurality of attributes of a plurality of data sets that are currently stored in the client device. If determining module 302 determines that the data caching criteria are satisfied, data processing module 306 deletes one data set in the plurality of data sets that is selected according to a data replacement rule and stores at least a portion of the specific data set that needs to be stored in the memory. More examples and details on the data caching criteria and the data replacement rules are explained above with reference to FIG. 1.

As used in the description of the invention and the appended claims, the terms of “cache” and “store” are exchangeable, and they are not fundamentally distinct from each other. Respective variations of “cache” and “store” are also exchangeable.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of caching data, comprising:
at a client device having one or more processors and memory for storing programs to be executed by the one or more processors:
receiving an instruction to operate based on a specific data set;
determining whether the specific data set is cached in the memory;
in accordance with a determination that the specific data set is not cached in the memory:
determining a plurality of attributes associated with a plurality of data sets currently stored in the memory, wherein the plurality of attributes at least include a number of data sets in the plurality of data sets and a total size of the plurality of data sets;
determining whether the plurality of attributes satisfy data caching criteria for storing the specific data set in the memory; and
in accordance with a determination that the data caching criteria are not satisfied:
selecting at least one of the plurality of data sets according to a data replacement rule;
deleting at least a portion of the selected data set from the memory; and
downloading the specific data set from a remote source;
storing at least a portion of the specific data set in the memory; and
operating the specific data set according to the user instruction.

2. The method of claim 1, wherein each of the plurality of data sets comprises audio data.

3. The method of claim 1, wherein in accordance with a determination that data caching criteria are not satisfied, the specific data set is cached in the memory without deleting any of the plurality of data sets cached in the memory.

4. The method of claim 1, wherein the data caching criteria are not satisfied, when a number of data sets in the plurality of data sets exceeds a first threshold value, and when a total size of the plurality of data sets and the first data set exceeds a second threshold value.

5. The method of claim 1, wherein the specific data set comprises a first data set, and the plurality of data sets comprise a second data set that are cached in the memory before other data sets in the plurality of data sets, and wherein in accordance with the data replacement rule, the second data set is selected, and at least a portion of the second data set is deleted to spare memory space for caching the portion of the first data set in the memory.

6. The method of claim 1, wherein in accordance with the data replacement rule, a third data set is selected and deleted to spare memory space for caching the portion of the specific data set in the memory, when the size of the specific data set is smaller than a respective size of at least one data set in the plurality of data sets, and wherein among the at least one data set that has a respective larger size than the specific data set, the third data set have a size closest to that of the specific data set.

7. The method of claim 1, wherein the specific data set comprises a first data set, and the plurality of data sets comprise a fourth data set that have not been accessed for a longest period time among the plurality of data sets, and wherein in accordance with the data replacement rule, the fourth data set is selected, and at least a portion of the fourth data set is deleted to spare memory space for caching the portion of the first data set in the memory.

8. The method of claim 1, wherein in accordance with the data replacement rule, a respective frequency of execution is tracked for each data set of the plurality of data sets, and the selected data set have the lowest frequency of execution among the plurality of data sets.

9. The method of claim 1, wherein a user of the client device determines that a list of data sets cached in the memory of the client device are not included in the plurality of data sets, such that data sets in the list of data sets are not selected according to the data replacement rule or deleted to spare memory space for the specific data set.

10. The method of claim 1, wherein each of the plurality of data sets is cached in a temporary data file.

11. The method of claim 1, wherein the portion of the specific data set comprises a firs subset of the specific data set, and wherein the method further comprises:
determining whether the portion of the specific data set includes a complete specific data set; and
in accordance with a determination that the portion of the specific data set does not include the complete specific data set, concurrently executing the instruction based on the first subset of the specific data set and caching a second subset of the specific data set.

12. A client device, comprising:
one or more processors; and
memory having instructions stored thereon, which when executed by the one or more processors cause the processors to perform operations, comprising:
receiving an instruction to operate based on a specific data set;
determining whether the specific data set is cached in the memory;
in accordance with a determination that the specific data set is not cached in the memory:
determining a plurality of attributes associated with a plurality of data sets currently stored in the memory, wherein the plurality of attributes at least include a number of data sets in the plurality of data sets and a total size of the plurality of data sets;
determining whether the plurality of attributes satisfy data caching criteria for storing the specific data set in the memory; and
in accordance with a determination that the data caching criteria are not satisfied:
selecting at least one of the plurality of data sets according to a data replacement rule;
deleting at least a portion of the selected data set from the memory; and
downloading the specific data set from a remote source;
storing at least a portion of the specific data set in the memory; and
operating the specific data set according to the user instruction.

13. The client device of claim 12, wherein each of the plurality of data sets comprises audio data.

14. The client device of claim 12, wherein the data caching criteria are not satisfied, when a number of data sets in the plurality of data sets exceeds a first threshold value, and when a total size of the plurality of data sets and the first data set exceeds a second threshold value.

15. The client device of claim 12, wherein in accordance with the data replacement rule, a third data set is selected and deleted to spare memory space for caching the portion of the specific data set in the memory, when the size of the specific data set is smaller than a respective size of at least one data set in the plurality of data sets, and wherein among the at least one data set that has a respective larger size than the specific data set, the third data set have a size closest to that of the specific data set.

16. The client device of claim 12, wherein in accordance with the data replacement rule, a respective frequency of execution is tracked for each data set of the plurality of data sets, and the selected data set have the lowest frequency of execution among the plurality of data sets.

17. The client device of claim 12, wherein a user of the client device determines that a list of data sets cached in the memory of the client device are not included in the plurality of data sets, such that data sets in the list of data sets are not selected according to the data replacement rule or deleted to spare memory space for the specific data set.

18. A non-transitory computer-readable medium, having instructions stored thereon, which when executed by one or more processors cause the processors to perform operations comprising:
receiving an instruction to operate based on a specific data set;
determining whether the specific data set is cached in the memory;
in accordance with a determination that the specific data set is not cached in the memory:
determining a plurality of attributes associated with a plurality of data sets currently stored in the memory, wherein the plurality of attributes at least include a number of data sets in the plurality of data sets and a total size of the plurality of data sets;
determining whether the plurality of attributes satisfy data caching criteria for storing the specific data set in the memory; and
in accordance with a determination that the data caching criteria are not satisfied:
selecting at least one of the plurality of data sets according to a data replacement rule;
deleting at least a portion of the selected data set from the memory; and
downloading the specific data set from a remote source;
storing at least a portion of the specific data set in the memory; and
operating the specific data set according to the user instruction.

19. The non-transitory computer-readable medium of claim 18, wherein the specific data set comprises a first data set, and the plurality of data sets comprise a fourth data set that have not been accessed for a longest period time among the plurality of data sets, and wherein in accordance with the data replacement rule, the fourth data set is selected, and at least a portion of the fourth data set is deleted to spare memory space for caching the portion of the first data set in the memory.

20. The non-transitory computer-readable medium of claim 18, wherein the portion of the specific data set comprises a first subset of the specific data set, and wherein the performed operations further comprise:
determining whether the portion of the specific data set includes a complete specific data set; and
in accordance with a determination that the portion of the specific data set does not include the complete specific data set, concurrently executing the instruction based on the first subset of the specific data set and caching a second subset of the specific data set.
